(19) United States
(12) Patent Application Publication
(10) Pub. No.: US 2025/0367710 A1
(43) Pub. Date: Dec. 4, 2025

(54) Traceless Cleaning Stick

(71) Applicant: Tingwei Cui, Shanghai (CN)

(72) Inventor: Tingwei Cui, Shanghai (CN)

(21) Appl. No.: 19/074,799

(22) Filed: Mar. 10, 2025

(30) Foreign Application Priority Data
May 28, 2024 (CN) 202421173674.7

(51) Int. Cl. B08B 1/14; B25G 3/34

(52) U.S. Cl. CPC B08B 1/143; B25G 3/34

(57) ABSTRACT

A traceless cleaning stick, comprising a cleaning handle, a cleaning head connecting handle, and a cleaning head body, and the cleaning handle, the cleaning head connecting handle, and the cleaning head body are fixed by welding; the cleaning head body is covered with a cleaning cloth; the cleaning head body comprises a cleaning upper arm, a cleaning lower arm, and a cleaning end head; one end of the cleaning upper arm is connected to the cleaning head connecting handle, and the other end thereof is connected to the cleaning end head; the cleaning lower arm is arranged at the lower part of the cleaning upper arm, one end of which is connected to the cleaning end head, and the other end thereof is not connected to the cleaning head connecting handle. The invention can reduce the hand gripping force generated by workers, better fit the surface of the wiped product.

### TECHNICAL FIELD

The invention relates to the technical field of cleaning devices, in particular to a traceless cleaning stick.

### BACKGROUND ART

Traceless cleaning sticks are mostly used for cleaning cloths and subtle places that cannot be reached by existing cleaning sticks, such as using a traceless cleaning stick dipped in alcohol cleaning solvents to clean precision instruments or electronic components, etc.; however, the current conventional cleaning sticks have specific shapes and specifications and can only remove residues in vertical corners. Some tiny corners are not wiped completely and the pressure is not balanced during operation, which will make the operator feel tired and cannot meet the use requirements well.

### SUMMARY OF THE INVENTION

In order to solve the above technical problems, the technical solutions provided by the invention are: a traceless cleaning stick, comprising a cleaning handle, a cleaning head connecting handle, and a cleaning head body, and the cleaning handle, the cleaning head connecting handle, and the cleaning head body are fixed by welding; the cleaning head body is covered with a cleaning cloth, including one of polyester fiber, microfiber, sponge, non-woven fabric, and dust-free cloth; the cleaning head body comprises a cleaning upper arm, a cleaning lower arm, and a cleaning end head; one end of the cleaning upper arm is connected to the cleaning head connecting handle, and the other end thereof is connected to the cleaning end head; the cleaning lower arm is arranged at the lower part of the cleaning upper arm, one end of which is connected to the cleaning end head, and the other end thereof is not connected to the cleaning head connecting handle; an acute angle is formed between the cleaning upper arm, the cleaning lower arm, and one end of the cleaning end head.

The advantages of the invention compared with the prior art are: the invention can reduce the hand gripping force generated by workers in the process of using dust-free sticks to wipe products, relieve workers' hand fatigue, and improve workers' production efficiency; the invention can better fit the surface of the wiped product, and the pressure distribution given by the dust-free stick of the invention to the surface of the wiped product is more uniform, the wiped product is cleaner, and the cleaning efficiency of the workshop products is improved; the dust-free stick of the invention can cooperate with the intelligent manipulator to complete the cleaning work and improve production efficiency; the traditional dust-free stick in the process of wiping the product, although the surface of the wiped product is clean, sometimes there will be scratches, which damages the quality of the wiped product; the dust-free stick of the invention will not cause the risk of scratching the wiped product in the process of wiping the product, ensuring the quality of the wiped product.

### BRIEF DESCRIPTION OF THE DRAWINGS

FIG. 1 is a schematic diagram of the upper structure in Embodiment 1 of the traceless cleaning stick according to the invention.

FIG. 2 is a schematic diagram of the lower structure in Embodiment 1 of the traceless cleaning stick according to the invention.

FIG. 3 is a schematic diagram of the side structure in Embodiment 1 of the traceless cleaning stick according to the invention.

FIG. 4 is a schematic diagram of the upper structure in Embodiment 2 of the traceless cleaning stick according to the invention.

FIG. 5 is a schematic diagram of the side structure in Embodiment 2 of the traceless cleaning stick according to the invention.

FIG. 6 is a schematic diagram of the upper structure in Embodiment 3 of the traceless cleaning stick according to the invention.

FIG. 7 is a schematic diagram of the upper structure in Embodiment 4 of the traceless cleaning stick according to the invention.

FIG. 8 is a schematic diagram of the lower structure in Embodiment 4 of the traceless cleaning stick according to the invention.

FIG. 9 is a schematic diagram of the side structure in Embodiment 4 of the traceless cleaning stick according to the invention.

FIG. 10 is a schematic diagram of the upper structure in Embodiment 5 of the traceless cleaning stick according to the invention.

FIG. 11 is a schematic diagram of the side structure in Embodiment 5 of the traceless cleaning stick according to the invention.

FIG. 12 is a first schematic diagram of the upper structure in Embodiment 6 of the traceless cleaning stick according to the invention.

FIG. 13 is a first schematic diagram of the side structure in Embodiment 6 of the traceless cleaning stick according to the invention.

FIG. 14 is a second schematic diagram of the upper structure in Embodiment 6 of the traceless cleaning stick according to the invention.

FIG. 15 is a second schematic diagram of the side structure in Embodiment 6 of the traceless cleaning stick according to the invention.

FIG. 16 is a schematic diagram of the upper structure in Embodiment 7 of the traceless cleaning stick according to the invention.

FIG. 17 is a schematic diagram of the lower structure in Embodiment 7 of the traceless cleaning stick according to the invention.

FIG. 18 is a schematic diagram of the side structure in Embodiment 7 of the traceless cleaning stick according to the invention.

FIG. 19 is a schematic diagram of the upper structure in Embodiment 8 of the traceless cleaning stick according to the invention.

FIG. 20 is a schematic diagram of the lower structure in Embodiment 8 of the traceless cleaning stick according to the invention.

FIGS. 21-29 are schematic diagrams of Embodiment 9 of the traceless cleaning stick according to the invention.

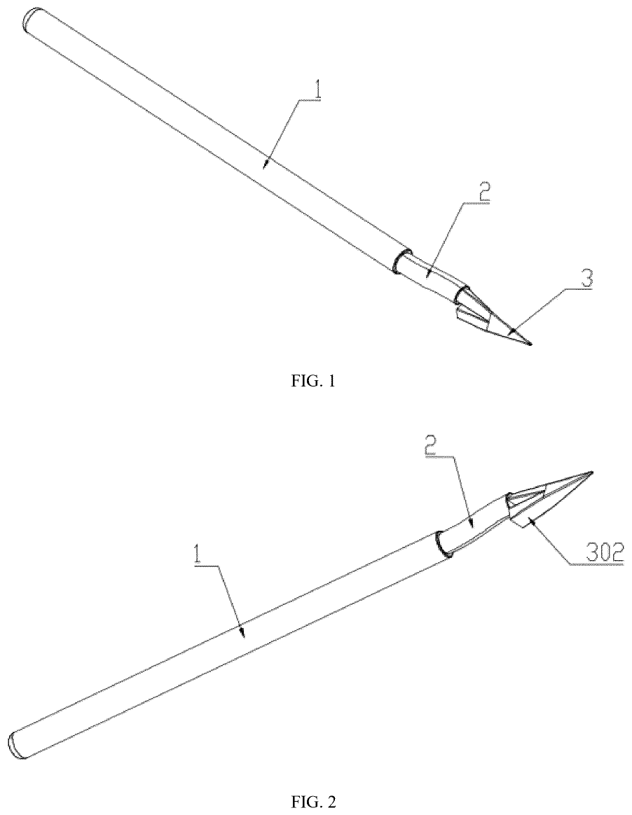

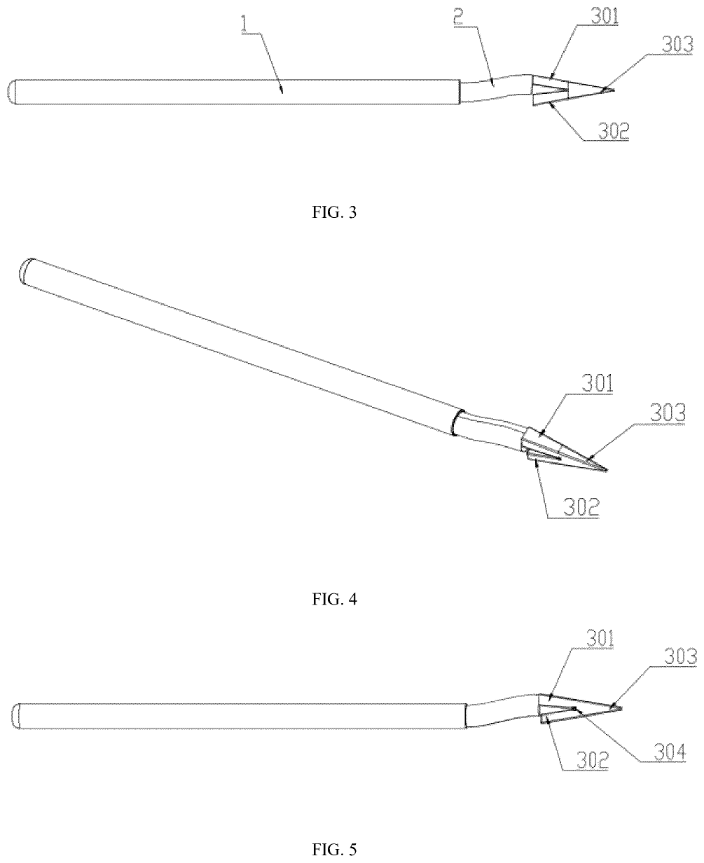

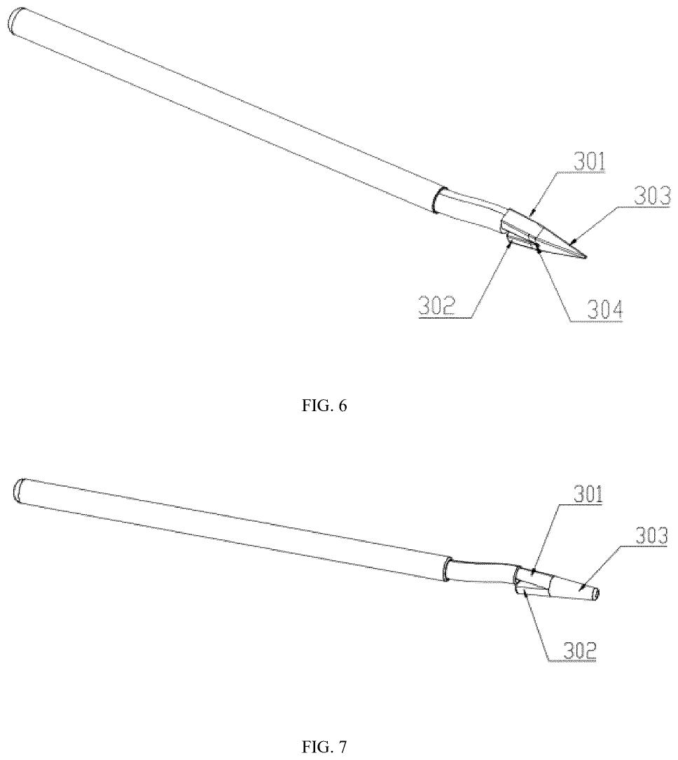

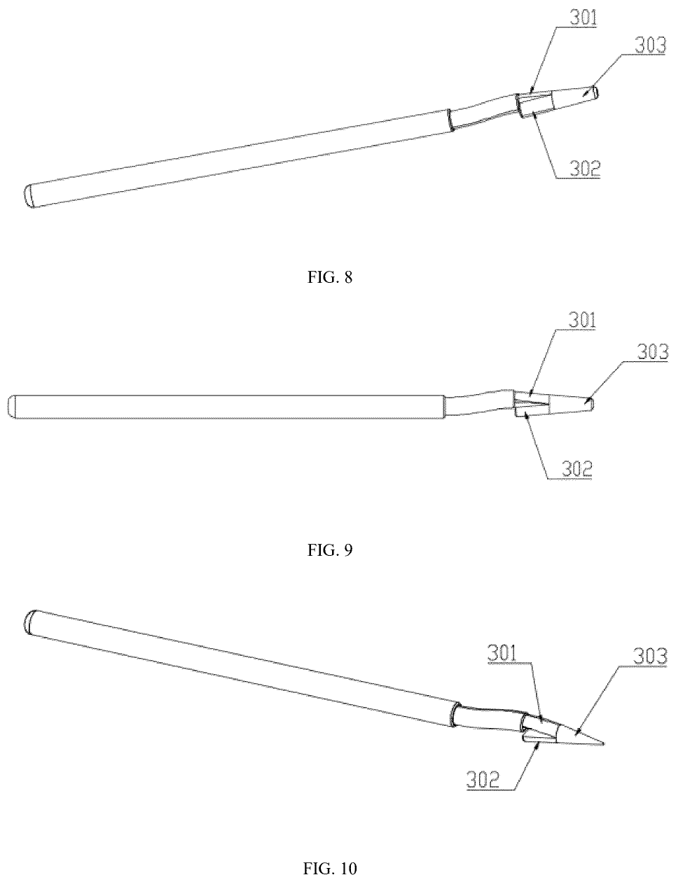

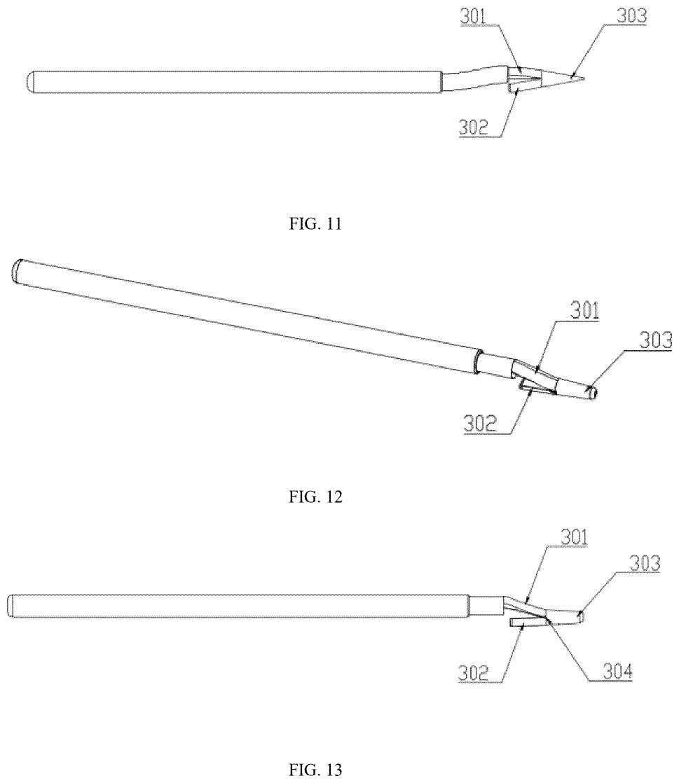

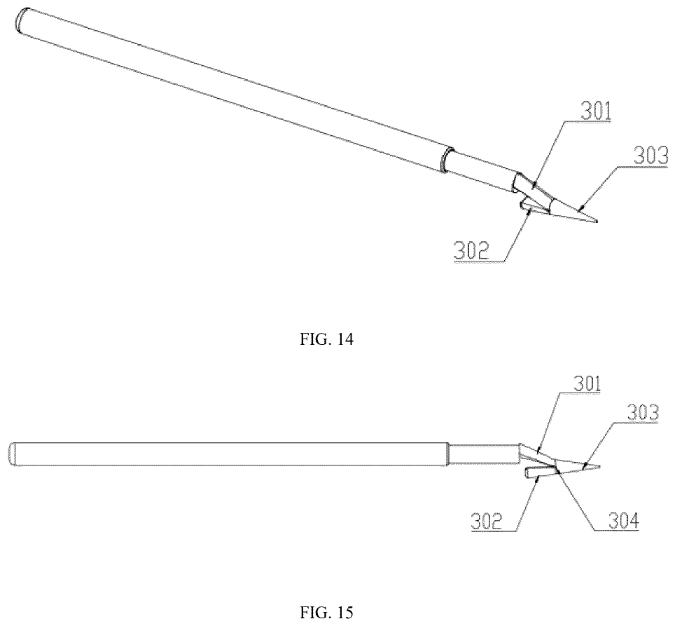

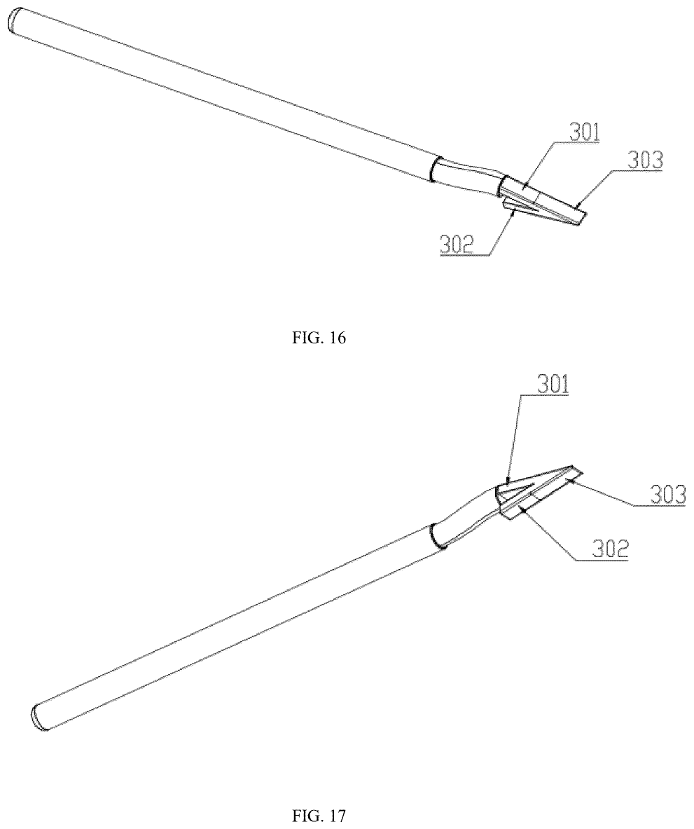

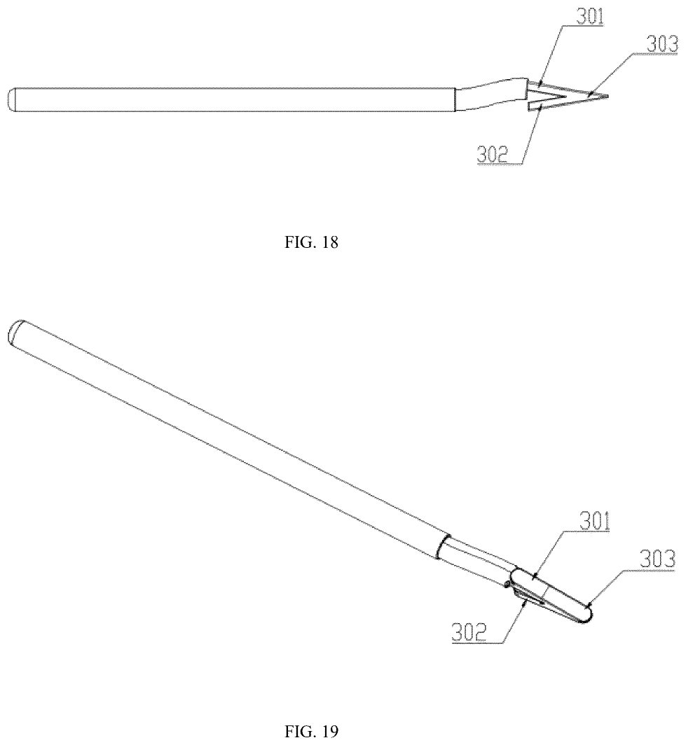

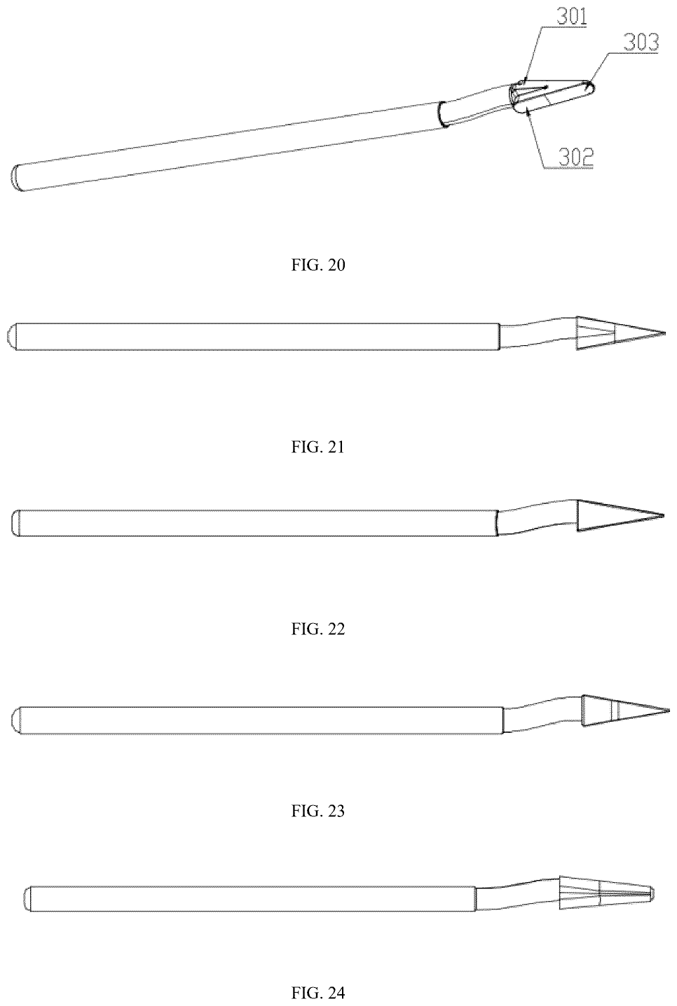

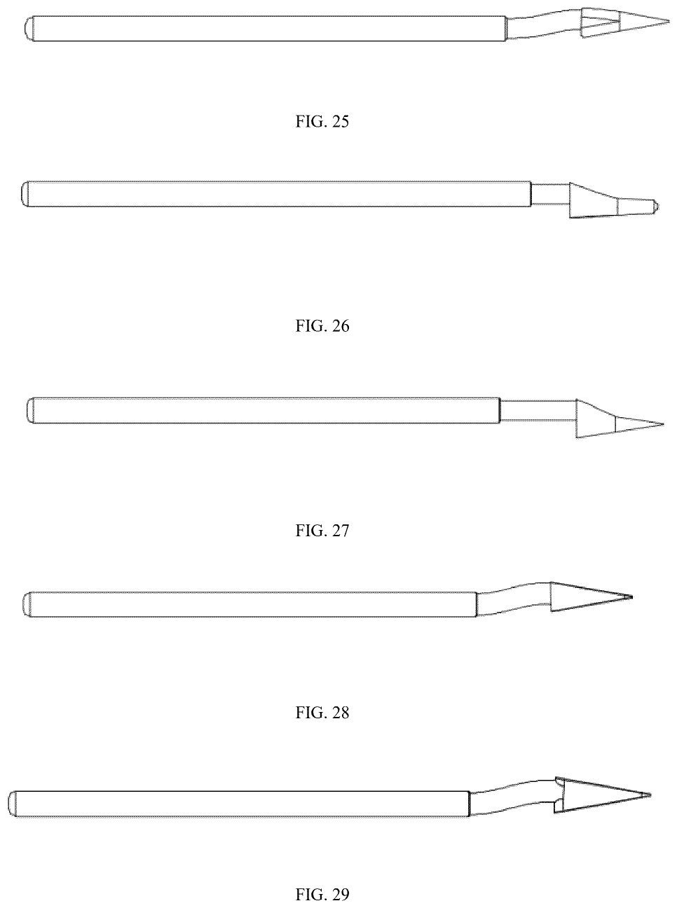

### SPECIFIC EMBODIMENT OF THE INVENTION

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments. The components of the embodiments of the invention generally described and illustrated in the drawings herein may be arranged and designed in various different configurations.

In the description of the invention, it needs to be understood that the orientation or positional relationship indicated by the terms “center”, “up”, “down”, “left”, “right”, “vertical”, “horizontal”, “inner”, “outer”, etc. are based on the orientation or positional relationship shown in the drawings, which are only for the convenience of describing the invention and simplifying the description, rather than indicating or implying that the device or element referred to must have a specific orientation, be constructed and operated in a specific orientation, and therefore cannot be understood as a limitation of the invention. In addition, the terms “first”, “second”, and “third” are only used for descriptive purposes, and cannot be understood as indicating or implying relative importance or implicitly indicating the number of indicated technical features.

In addition, the terms “horizontal”, “vertical”, “dangling”, etc. do not mean that the component is required to be absolutely horizontal or hanging, but may be slightly inclined. For example, “horizontal” only means that its direction is more horizontal than “vertical”, it does not mean that the structure must be completely horizontal, but can be slightly inclined.

In the description of the invention, “plurality” means at least two.

In the invention, unless otherwise clearly defined and limited, the terms “provided”, “installed”, “connected” and other terms should be interpreted broadly; for example, it can be a fixed connection, it can be a detachable connection, or integrated; it can be a mechanical connection or an electrical connection; it can be a direct connection, or an indirectly connection through an intermediate medium, and it can be an internal communication between two elements or the interaction relationship between two elements. For those of ordinary skill in the art, the specific meaning of the above terms in the invention can be understood according to specific circumstances.

### Embodiment 1

A traceless cleaning stick, comprising a cleaning handle 1, a cleaning head connecting handle 2, and a cleaning head body 3, and the cleaning handle 1, the cleaning head connecting handle 2, and the cleaning head body 3 are fixed by welding; the cleaning head body 3 is covered with a cleaning cloth, including one of polyester fiber, microfiber, sponge, non-woven fabric, and dust-free cloth; the cleaning head body 3 comprises a cleaning upper arm 301, a cleaning lower arm 302, and a cleaning end head 303; one end of the cleaning upper arm 301 is connected to the cleaning head connecting handle 2, and the other end thereof is connected to the cleaning end head 303; the cleaning lower arm 302 is arranged at the lower part of the cleaning upper arm 301, one end of which is connected to the cleaning end head 303, and the other end thereof is not connected to the cleaning head connecting handle 2; an acute angle is formed between the cleaning upper arm 301, the cleaning lower arm 302, and one end of the cleaning end head 303; the cleaning end head 303 and the cleaning upper arm 301 are both in the shape of a triangular pyramid, and the cleaning lower arm 302 is in the shape of a trapezoid.

### Embodiment 2

Compared with Embodiment 1, in this embodiment, the cleaning upper arm 301, the cleaning lower arm 302, and the cleaning end head 303 form a quadrangular pyramid, and a circular hole 304 is provided at one end where the cleaning upper arm 301, the cleaning lower arm 302, and the cleaning end head 303 are connected.

### Embodiment 3

Compared with Embodiment 2, in this embodiment, the cleaning end head 303 is in the shape of a quadrangular pyramid, and the cleaning upper arm 301 and the cleaning lower arm 302 are in the shape of a square cylinder.

### Embodiment 4

Compared with Embodiment 1, in this embodiment, the cleaning end head 303 is a cylinder, and the cross sections of the cleaning upper arm 301 and the cleaning lower arm 302 are semicircular.

### Embodiment 5

Compared with Embodiment 4, in this embodiment, the cleaning end head 303 is a cone, and the cross sections of the cleaning upper arm 301 and the cleaning lower arm 302 are semicircular.

### Embodiment 6

Compared with Embodiments 4 and 5, in this embodiment, an obtuse angle is formed between the cleaning upper arm 301 and the cleaning end head 303, and a circular hole 304 is provided at one end where the cleaning upper arm 301, the cleaning lower arm 302, and the cleaning end head 303 are connected.

### Embodiment 7

Compared with Embodiment 1, in this embodiment, the cleaning upper arm 301, the cleaning lower arm 302, and the cleaning end head 303 form a column with a triangular cross section.

### Embodiment 8

Compared with Embodiment 7, in this embodiment, the ends of the cleaning upper arm 301, the cleaning lower arm 302, and the cleaning end head 303 away from each other are arranged as arc ends, and the ends of the cleaning upper arm 301 and the cleaning lower arm 302 connected to the cleaning end head 303 are arranged with circular holes 304.

### Embodiment 9

Compared with Embodiments 1-8, in this embodiment, the cleaning upper arm 301 and the cleaning lower arm 302 are integrally formed without any gap therebetween.

In specific implementation, the cleaning head body or cleaning end head in the shape of a triangular pyramid can perfectly extend into the gaps that are difficult to clean for wiping and cleaning; the conical or cylindrical cleaning head body or cleaning end head has a large wiping contact area and has a self-adjusting pressure compared to the traditional one, which can better contact the object being wiped; the circular hole provided between the cleaning upper arm and the cleaning lower arm can adjust the pressure between the cleaning upper arm and the cleaning lower arm according to the specific situation, that is, the cleaning upper arm and the cleaning lower arm can be adjusted to be close to each other, and any cross-section of the wiping side can be adjusted, so that the cleaning head body with circular holes is more flexible and fits better than the cleaning head body without circular holes.

When the invention is in use, the cleaning stick head with an inclined angle increases the use area of the product, can improve the cleaning efficiency, can effectively clean a narrow and deep space, and the cleaning stick can quickly absorb oil stains and is not easy to be damaged.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

1. A traceless cleaning stick, comprising a cleaning handle, a cleaning head connecting handle, and a cleaning head body, and the cleaning handle, the cleaning head connecting handle, and the cleaning head body are fixed by welding; the cleaning head body is covered with a cleaning cloth, including one of polyester fiber, microfiber, sponge, non-woven fabric, and dust-free cloth; the cleaning head body comprises a cleaning upper arm, a cleaning lower arm, and a cleaning end head; one end of the cleaning upper arm is connected to the cleaning head connecting handle, and the other end thereof is connected to the cleaning end head; the cleaning lower arm is arranged at the lower part of the cleaning upper arm, one end of which is connected to the cleaning end head, and the other end thereof is not connected to the cleaning head connecting handle; an acute angle is formed between the cleaning upper arm, the cleaning lower arm, and one end of the cleaning end head.

2. The traceless cleaning stick according to claim 1, wherein the cleaning end head and the cleaning upper arm are both in the shape of a triangular pyramid, and the cleaning lower arm is in the shape of a trapezoid.

3. The traceless cleaning stick according to claim 1, wherein the cleaning upper arm, the cleaning lower arm, and the cleaning end head form a quadrangular pyramid, and a circular hole is provided at one end where the cleaning upper arm, the cleaning lower arm, and the cleaning end head are connected.

4. The traceless cleaning stick according to claim 1, wherein the cleaning end head is a cylinder, and the cross sections of the cleaning upper arm and the cleaning lower arm are semicircular.

5. The traceless cleaning stick according to claim 1, wherein the cleaning end head is a cone, and the cross sections of the cleaning upper arm and the cleaning lower arm are semicircular.

6. The traceless cleaning stick according to claim 5, wherein an obtuse angle is formed between the cleaning upper arm and the cleaning end head, and a circular hole is provided at one end where the cleaning upper arm, the cleaning lower arm, and the cleaning end head are connected.

7. The traceless cleaning stick according to claim 1, wherein the cleaning end head is in the shape of a quadrangular pyramid, and the cleaning upper arm and the cleaning lower arm are in the shape of a square cylinder.

8. The traceless cleaning stick according to claim 1, wherein the cleaning upper arm, the cleaning lower arm, and the cleaning end head form a column with a triangular cross section.

9. The traceless cleaning stick according to claim 1, wherein the ends of the cleaning upper arm, the cleaning lower arm, and the cleaning end head away from each other are arranged as arc ends, and the ends of the cleaning upper arm and the cleaning lower arm connected to the cleaning end head are arranged with circular holes.

10. The traceless cleaning stick according to claim 1, wherein the cleaning upper arm and the cleaning lower arm are integrally formed without any gap therebetween.
